(19) United States
(12) Patent Application Publication
(10) Pub. No.: US 2026/0032379 A1
(43) Pub. Date: Jan. 29, 2026

(54) Reactive Filter for Amplification of Transducer Ultrasound

(71) Applicant: Apple Inc., Cupertino, CA (US)

(72) Inventors: Onur I. Ilkorur, Santa Clara, CA (US); Reza Ghaffarivardavagh, San Jose, CA (US); Samer Dagher, Broomfield, CO (US); Gokhan Hatipoglu, Milpitas, CA (US); Christopher Wilk, Los Gatos, CA (US); Peter C. Hrudey, San Jose, CA (US)

(21) Appl. No.: 19/253,388

(22) Filed: Jun. 27, 2025

Related U.S. Application Data
(60) Provisional application No. 63/674,684, filed on Jul. 23, 2024.
(60) Provisional application No. 63/811,325, filed on May 23, 2025.

(51) Int. Cl. H04R 1/28

(52) U.S. Cl. CPC H04R 1/2888; H04R 2201/003

(57) ABSTRACT

A reactive filter assembly comprising a reactive filter acoustically coupled to a transducer operable to generate an audio frequency by air non-linearity demodulation of an ultrasonic frequency, the reactive filter having a number of acoustic pathways tuned to introduce a radiation impedance to the transducer that improves transducer efficiency.

### CROSS-REFERENCE TO RELATED APPLICATION

This application is a non-provisional application of co-pending U.S. Provisional Patent Application No. 63/674,684, filed Jul. 23, 2024, and U.S. Provisional Patent Application No. 63/811,325, filed May 23, 2025, and incorporated herein by reference.

### FIELD

An aspect of the disclosure is directed to a reactive filter that improves efficiency of a transducer configured to generate an audio frequency by air non-linearity demodulation of an ultrasonic frequency. Other aspects are also described and claimed.

### BACKGROUND

Portable communications or listening devices (e.g., smart phones, earphones, etc.) have within them one or more transducers that convert an input electrical audio signal into a sound pressure wave output that can be heard by the user, or a sound pressure wave input into an electrical audio signal. The transducer (e.g., a speaker) can be used to, for example, output sound pressure waves corresponding to the voice of a far end user, such as during a telephone call, or to output sound pressure waves corresponding to sounds associated with a game or music the user wishes to play. Due to the relatively low profile of the portable devices, the transducers also have a relatively low profile, which in turn, can make it difficult to maintain optimal sound quality. In addition, it may be desirable to attenuate certain ultrasound amplitudes or frequency ranges output by the transducers or otherwise near the ear of the user for health and safety reasons, while still outputting lower frequencies to the user's ear.

### SUMMARY

Aspects of the disclosure are directed to a reactive filter that improves efficiency of a transducer configured to generate an audio frequency by air non-linearity demodulation of an ultrasonic frequency. For example, the transducer may be a microelectromechanical systems (MEMS) transducer that uses ultrasonic frequencies to generate audio frequencies. Representatively, the MEMS transducer or speaker may use ultrasonic modulation and demodulation techniques to generate audible sound. For example, the MEMS transducer may generate ultrasonic frequencies, then air non-linearity in the environment outside of the transducer demodulates the ultrasonic frequencies into audio frequencies or an audio sound output. In this aspect, the demodulation and generation of audible sound from the ultrasonic frequencies output by the transducer occurs outside of the transducer. It may further be understood that changing or altering the air impedance, and in turn radiation impedance of the transducer, alters the efficiency (e.g., sound output) of the transducer. For example, increasing the air or radiation impedance may amplify the ultrasonic frequency output by the transducer, which in turn, amplifies or boosts the audio frequency or sound wave output by the transducer thus improving efficiency. The reactive filter may therefore be coupled to the output port of the transducer to introduce a radiation impedance to the transducer that, in turn, improves transducer efficiency. For example, without the reactive filter, the radiation impedance may be low and the air non-linearity generates a particular audio output from the ultrasonic frequency output by the transducer. Adding the reactive filter to the transducer will increase the radiation impedance, which in turn amplifies the ultrasonic frequency output by the transducer and may significantly amplify the audio output generated from the ultrasonic frequency. For example, in some aspects, without the reactive filter, the transducer may have an ultrasonic frequency output (e.g., greater than 20 kHz) of around 115 decibels (dB) and an audible frequency output (e.g., 20 Hz to about 20 kHz) of around 50 dB. When the reactive filter is added the ultrasonic frequency output may increase to 122 dB, and this 7 dB increase may translate to almost a 20 dB gain in audio frequency output.

In this aspect, the reactive filter may have a geometry including a number of acoustic pathways with geometries tuned to introduce a radiation impedance to the transducer that amplifies or boosts the audio output. For example, in some aspects, each of the acoustic pathways may include at least two different cross-sectional dimensions. For example, each acoustic pathway may include an acoustic cavity having one cross-sectional dimension and a neck that couples the acoustic cavity to the transducer and has a different cross-sectional dimension. In some aspect, the acoustic cavity may have a greater cross-sectional dimension than the neck. In addition, in still further aspects, each acoustic pathway may also include another neck coupling the acoustic cavity to an attenuator that is configured to attenuate the ultrasonic frequency output by the transducer, once the audio frequency is generated, so that the ultrasonic frequency is not output to the user. It should further be understood that while the term “filter” is used, the “reactive filter” is not actually removing or otherwise separating out an unwanted component. Rather, the reactive filter is a reactive component or amplifier that is configured to alter the radiation impedance of the transducer to improve transducer efficiency (e.g., amplify sound output) as discussed here.

In some aspects, a reactive filter assembly is provided including a reactive filter acoustically coupled to a transducer operable to generate an audio frequency by air non-linearity demodulation of an ultrasonic frequency, the reactive filter having a number of acoustic pathways tuned to introduce a radiation impedance to the transducer that improves transducer efficiency. In some aspects, the reactive filter increases the radiation impedance to the transducer to improve the transducer efficiency. In still further aspects, the radiation impedance causes an amplified ultrasonic frequency output that leads to a gain in audio frequency output. In some aspects, the reactive filter comprises a low-pass filter. In some aspects, each acoustic pathway of the number of acoustic pathways comprise an acoustic cavity, a first neck coupling the acoustic cavity to the transducer and a second neck. In other aspects, a cross-sectional dimension of the acoustic cavity is greater than a cross-sectional dimension of the first neck and the second neck. In still further aspects, the first neck and the second neck have a same cross-sectional dimension, and the acoustic cavity has a cross-sectional dimension greater than the cross-sectional dimension of the first neck and the second neck. In other aspects, the second neck couples the acoustic cavity to an attenuator configured to attenuate the ultrasonic frequency output by the transducer with the audio frequency.

In other aspects, a transducer assembly includes a transducer operable to generate an audio frequency by air non-linearity demodulation of an ultrasonic frequency; and a reactive filter assembly coupled to the transducer and having an acoustic pathway comprising a first cross-sectional dimension and a second cross-sectional dimension tuned to introduce a radiation impedance to the transducer that improves transducer efficiency. In some aspects, the reactive filter assembly increases the radiation impedance to the transducer to improve the transducer efficiency. In other aspects, the radiation impedance causes an amplified ultrasonic frequency output that leads to a gain in audio frequency output. In still further aspects, the reactive filter assembly comprises a low pass filter. In other aspects, the first cross-sectional dimension defines an acoustic cavity and the second cross-sectional dimension defines a first neck coupling the acoustic cavity to the transducer and a second neck. In still further aspects, the first cross-sectional dimension of the acoustic cavity is greater than a cross-sectional dimension of the first neck and the second neck. In other aspects, the second neck couples the acoustic cavity to an attenuator configured to attenuate the ultrasonic frequency output by the transducer with the audio frequency. In some aspects, the acoustic pathway is a first acoustic pathway, and the reactive filter assembly comprises a second acoustic pathway. In some aspects, the transducer comprises a microelectromechanical systems speaker.

In some aspects, a portable electronic device includes a device enclosure having an enclosure wall defining an interior chamber separated from a surrounding ambient environment; a transducer positioned within the interior chamber and operable to generate an audio frequency by air non-linearity demodulation of an ultrasonic frequency; and a reactive filter assembly coupled to the transducer and having a number of acoustic pathways tuned to introduce a radiation impedance to the transducer that improves transducer efficiency. In other aspects, the reactive filter assembly increases the radiation impedance to the transducer to improve the transducer efficiency. In some aspects, the radiation impedance causes an amplified ultrasonic frequency output that leads to a gain in audio frequency output. In other aspects, the reactive filter assembly comprises a low pass filter. In some aspects, each acoustic pathway of the number of acoustic pathways comprise an acoustic cavity, a first neck coupling the acoustic cavity to the transducer and a second neck. In other aspects, a cross-sectional dimension of the acoustic cavity is greater than a cross-sectional dimension of the first neck and the second neck. In still further aspects, the first neck and the second neck have a same cross-sectional dimension, and the acoustic cavity has a cross-sectional dimension greater than the cross-sectional dimension of the first neck and the second neck. In some aspects, the second neck couples the acoustic cavity to an attenuator configured to attenuate the ultrasonic frequency output by the transducer with the audio frequency.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect in this disclosure are not necessarily to the same aspect, and they mean at least one.

FIG. 1 illustrates a cross-sectional side view of one aspect of a reactive filter assembly.

FIG. 2 illustrates a magnified cross-sectional side view of one aspect of the reactive filter of FIG. 1.

FIG. 3 illustrates a perspective cut out view of one aspect of the reactive filter of FIG. 1.

FIG. 4 illustrates a block diagram of one aspect of an electronic device within which the attenuator assembly of FIG. 1-FIG. 3 may be implemented.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

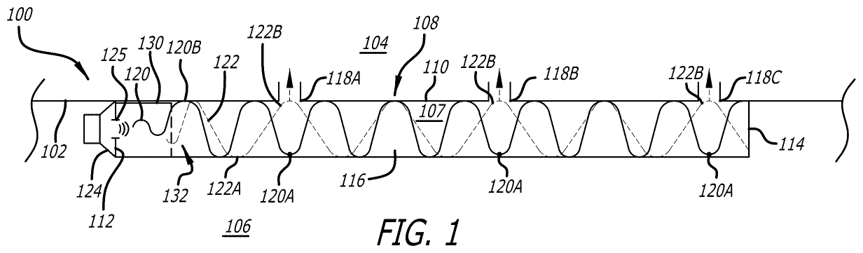

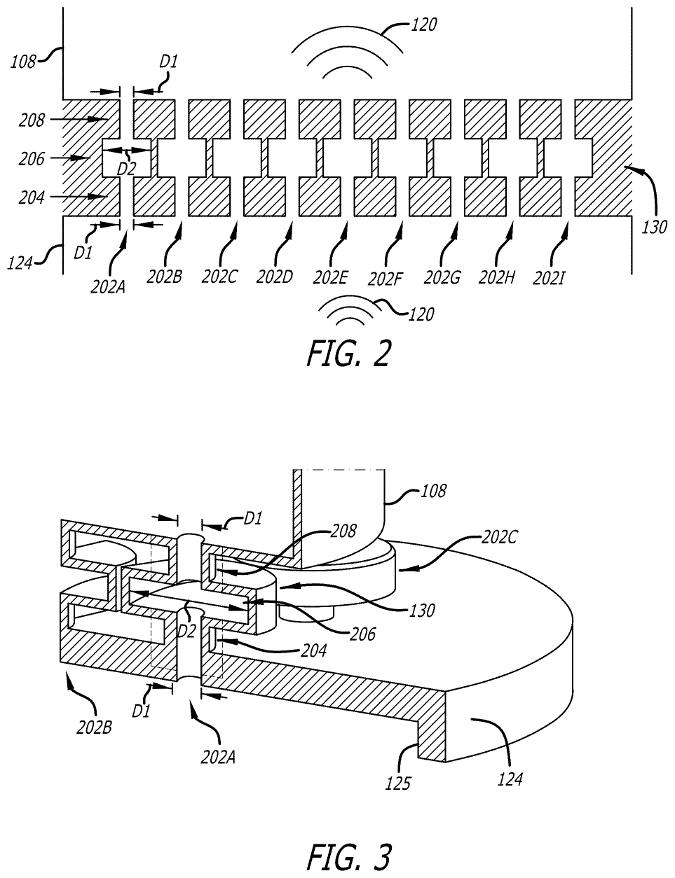

FIG. 1 illustrates a cross-sectional side view of an aspect of a reactive filter assembly. Reactive filter assembly 100 may include an enclosure or housing 102 having one or more walls or portions that are sealed together to form an interior cavity or chamber 106 that is separated from a surrounding ambient environment 104. Enclosure or housing 102 may be a relatively rigid structure that forms an electronic device enclosure. Representatively, in some aspects, enclosure or housing 102 may form an earpiece or a wearable device enclosure. In some aspects, the portions or walls may be considered fixed structures that can be snap-fit, welded, adhered or attached in a sealed manner together to form the desired type of housing 102. The interior chamber 106 defined by housing 102 may contain a transducer 124 configured to generate audible sound that may be output to the surrounding ambient environment 104, and more specifically, an car of a nearby user. In some aspects, transducer 124 may be a microelectromechanical systems (MEMS) transducer or speaker that uses ultrasonic modulation and demodulation techniques to generate the audible sound. For example, the MEMS transducer may generate ultrasonic frequencies 120, then air non-linearity in the environment outside of the transducer demodulates the ultrasonic frequencies 120 into audio frequencies or an audio sound output 122. In this aspect, the demodulation and generation of audible sound from the ultrasonic frequencies output by the transducer occurs outside of the transducer. In addition, as previously discussed, changing or altering the air impedance, and in turn radiation impedance of the transducer, alters the efficiency (e.g., sound output) of the transducer. For example, increasing the air or radiation impedance may amplify the ultrasonic frequency output by the transducer, which in turn, amplifies or boosts the audio frequency or sound wave output by the transducer thus improving efficiency. Reactive filter 130 may therefore be coupled to the output port 125 of the transducer 124 to introduce a radiation impedance to the transducer 124 that, in turn, improves transducer efficiency. For example, reactive filter 130 may have a geometry that increases the radiation impedance of transducer 124, which in turn amplifies the ultrasonic frequency output by the transducer 124 and may significantly amplify the audio output 122 generated from the ultrasonic frequency. In some aspects, reactive filter 130 may be, for example, a low-pass filter which instead of being used to filter certain frequencies, is configured to introduce additional radiation impedance to transducer 124 to improve the overall efficiency of transducer 124. The specific geometry of reactive filter 130 will be described in more details in reference to FIG. 2

In addition to the audible sound, however, there may be ultrasonic frequencies that are also output to the ambient environment by transducer 124. To reduce the output of the ultrasonic frequencies to the ambient environment, and more particularly near the car, attenuator 108 may be coupled to reactive filter 130. Attenuator 108 may be configured to attenuate undesirable ultrasonic frequencies output by transducer 124 before reaching the ambient environment 104. Representatively, attenuator 108 may be connected at one end to output port 132 of reactive filter 130 and be configured to output or otherwise leak audible or desired sound 122 to the ambient environment 104 while attenuating or otherwise preventing the output of undesirable ultrasonic waves or frequencies 120. Representatively, attenuator 108 may be formed by one or more walls 110, 112, 114, 116 that are connected to housing 102 and define an acoustic chamber 107. For example, attenuator 108 may include a side wall 110 and a side wall 116 that run parallel to one another and are connected by an end wall 114 that closes or otherwise seals the end of acoustic chamber 107. The other end wall 112 of attenuator 108 may be open, or otherwise form an opening, and be coupled to reactive filter 130. Transducer 124 may output acoustic waves 120 within an ultrasonic frequency range to reactive filter 130, which may then amplify ultrasonic waves 120 and output them to acoustic chamber 107 of attenuator 108 where the air non-linearity translates the ultrasonic waves 120 to acoustic waves 122 within an audible frequency range. Attenuator 108 may further include a number of openings 118A, 118B, 118C between acoustic chamber 107 and ambient environment 104 to output audible sound or acoustic waves to the ambient environment 104 (e.g., to an car of a nearby user). Openings 118A-C may be formed at positions and/or locations along side wall 110 of attenuator 108 selected to output or otherwise leak audible or desired sound waves through openings 118A-C to the surrounding ambient environment 104, while attenuating or otherwise preventing undesirable ultrasonic frequencies from leaking through openings 118A-C. To attenuate these undesirable ultrasonic frequencies, attenuator 108 may have a length that is an integer (N) multiple of the wavelength of a frequency of the carrier and/or modulator frequency represented by acoustic wave 120. Acoustic wave 120 (e.g., representing the ultrasonic frequency) forms a longitudinal wave within the acoustic chamber 107 having pressure minimum points represented by dips or nulls 120A and pressure maximum points represented by peaks 120B along its length. This pattern may be referred to as a standing wave, as the progressing waves and the reflected waves coincide at the same location at the same time intervals over the length. The acoustic wave 122 within acoustic chamber 107 may be within an audible or relatively low frequency range compared to the ultrasonic frequencies such that the pressure minimum points or nulls 122A and pressure maximum points or peaks 122B of wave 122 will not share all the same locations of the ultrasonic wave 120. Rather, acoustic wave 122 may have pressure maximum points or peaks 122B at locations along attenuator 108 which coincide with some of the pressure minimum points or nulls 120A of acoustic wave 120 as shown. At the pressure minimum points, there will be no or only minimal energy flow (e.g., close to zero pressure), while at the pressure maximum points there will be maximum energy flow. Accordingly, forming openings 118A-C at locations along attenuator side wall 110 that coincide with pressure minimum points 120A of the high frequency wave 120 (e.g., ultrasonic frequency wave) and the pressure maximum points of the low frequency wave 122 (e.g., audible frequency wave) as shown, will allow the desired audible tone represented by low frequency wave 122 to leak out of openings 118A-C without leaking, or with only minimal leaking of, the ultrasonic frequencies represented by wave 120 through openings 118A-C. In this aspect, attenuator 108 outputs the audio tones (e.g., within an audible frequency range) from transducer 124, and which are amplified using filter 130, to the ambient environment 104 while attenuating the undesirable ultrasonic frequencies (e.g., within an ultrasonic frequency range). It should be understood that attenuator 108 is one representative attenuator, however, any other type of attenuator suitable for attenuating ultrasonic frequencies may be coupled to filter 130. In addition, it should be understood that in some aspects, openings 118A-C may not all be open all the way to the closed end 114 of attenuator 108. Rather, in order to support the standing wave build-up inside attenuator 108, one or two of openings 118A-C, for example openings 118B and 118C may be closed. This helps the standing wave reach a higher pressure gradient between the pecks and the nulls, allowing the air-nonlinearity demodulation to become more efficient in the demodulation.

Referring now to FIG. 2, FIG. 2 illustrates a magnified cross-sectional side view of the reactive filter assembly of FIG. 1. From this view, it can be seen that reactive filter assembly 130 may include a number of acoustic pathways 202A, 202B, 202C, 202D, 202E, 202F, 202G, 202H, 202I that are acoustically coupled at one end to transducer 124 and the other end to attenuator 108. Each of acoustic pathways 202A-I may have a geometry tuned to introduce a radiation impedance to transducer 124 and boost or otherwise improve an efficiency of transducer 124. Representatively, in some aspects, acoustic pathways 202A-I may be made up of sections or portions having different cross-sectional dimensions D1 and D2. For example, in some aspects, acoustic pathways 202A-I may include a neck portion 204 having a cross-sectional dimension D1, an acoustic cavity portion 206 having a cross-sectional dimension D2 and another neck portion 208 having a cross-sectional dimension D2. The cross-sectional dimensions D1 of neck portions 204, 208 may be the same, and may be narrower or less than the cross-sectional dimension D2 of acoustic cavity portion 206. Said another way the cross-sectional dimension D2 of acoustic cavity portion 206 may be wider or greater than the cross-sectional dimension D1 of neck portions 204, 208. In some aspects, neck portion 204 may extend from one side of acoustic cavity 206 and connect acoustic cavity 206 to acoustic output port of transducer 124. Neck portion 208 may extend from an opposite side of acoustic cavity 206 and connect acoustic cavity 206 to attenuator 108. In this aspect, ultrasonic frequency waves 120 output by transducer 124 may pass through neck portion 204 to acoustic cavity 206 and then out neck portion 108 of each of acoustic pathways 202A-I to reactive filter 108. In this aspect, acoustic pathways 202A-I introduce an air and/or radiance impedance to transducer 124 which amplifies or boosts frequency waves 120 output by transducer 124 and, in turn, amplifies or boosts the audio waves generated from the ultrasonic frequencies using air-nonlinearity as previously discussed. Representatively, acoustic pathways 202A-I may increase an air or radiation impedance to amplify the ultrasonic frequency 120 output by the transducer 124, which in turn, amplifies or boosts the audio frequency or sound wave output by the transducer thus improving efficiency.

As can further be seen from the magnified perspective cut-out view of a representative acoustic pathway 202A of filter 130 illustrated by FIG. 3, in some aspects neck portions 204, 208 and acoustic cavity 206 may have a cylindrical cross-sectional geometry. In addition, neck portion 204 is connected to and opens to the output port 125 of transducer 124 and neck portion 208 is connected to and opens to attenuator 108. Acoustic cavity 206 is between neck portions 204 and 208 such that each of neck portions 204 and 208 extend from opposite sides of acoustic cavity 206. In some aspects, neck portions 204, 208 may extend from the center of acoustic cavity 206 and may be axially aligned with one another. Acoustic cavity 206 may have a wider cross-sectional dimension D2 than the cross-sectional dimension D1 of neck portions 204, 208. For example, cross-sectional dimension D2 may be at least two times that of D1, or at least three times that of D1. In addition, it may be understood that while neck portions 204, 208 are shown having a same cross-sectional dimension D1, in some aspects, they may have different cross-sectional dimensions. It can be further seen from FIG. 3 that the acoustic pathways 202A, 202B, 202C may each have substantially the same geometry and be arranged at different locations along port 125 of transducer 124, for example, next to one another and/or in front or behind one another. In other aspects, each of acoustic pathways 202A, 202B, 202C may have different geometries. In some aspects, reactive filter 130 may be a low-pass filter operable to introduce a radiation impedance increase to transducer 124 and increase efficiency. In still further aspects, reactive filter 130 may be any type of reactive filter which can introduce a radiation impedance increase to a MEMS transducer which uses air-nonlinearity demodulation which takes place outside the transducer, to produce audible sound.

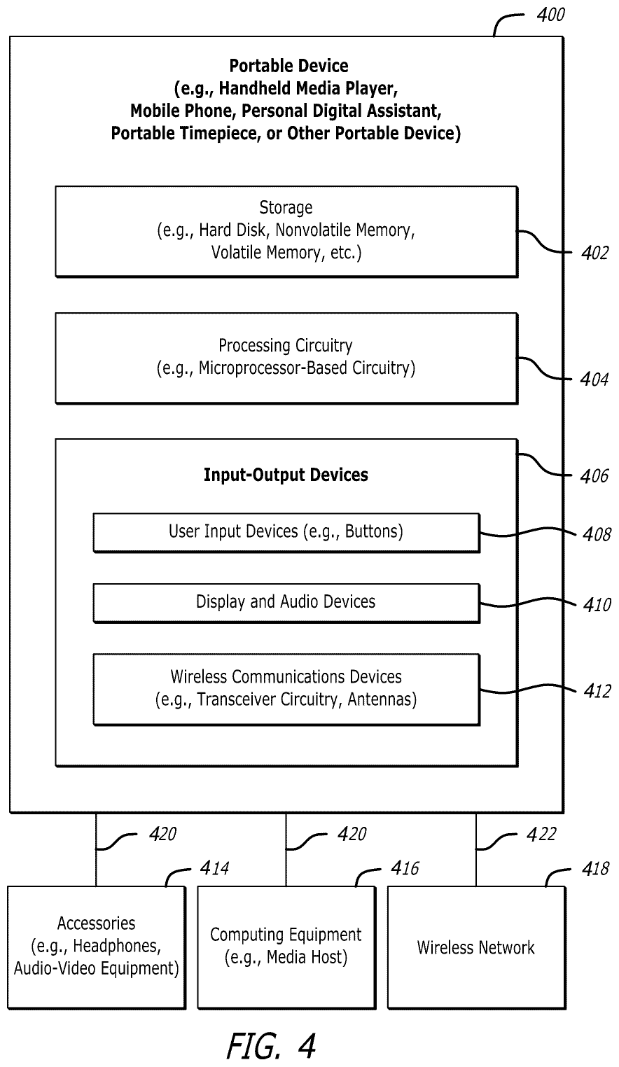

Referring now to FIG. 4, FIG. 4 illustrates a block diagram of one aspect of an electronic device within which the previously discussed speaker may be implemented. As shown in FIG. 4, device 400 may include storage 402. Storage 402 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 404 may be used to control the operation of device 400. Processing circuitry 404 may be based on a processor such as a microprocessor and other suitable integrated circuits. With one suitable arrangement, processing circuitry 404 and storage 402 are used to run software on device 400, such as internet browsing applications, voice-over-internet-protocol (VOIP) telephone call applications, email applications, media playback applications, operating system functions, etc. Processing circuitry 404 and storage 402 may be used in implementing suitable communications protocols. Communications protocols that may be implemented using processing circuitry 404 and storage 402 include internet protocols, wireless local area network protocols (e.g., IEEE 802.11 protocols—sometimes referred to as Wi-Fi®), protocols for other short-range wireless communications links such as the Bluetooth® protocol, protocols for handling 3G or 4G communications services (e.g., using wide band code division multiple access techniques), 2G cellular telephone communications protocols, etc.

To minimize power consumption, processing circuitry 404 may include power management circuitry to implement power management functions. For example, processing circuitry 404 may be used to adjust the gain settings of amplifiers (e.g., radio-frequency power amplifier circuitry) on device 400. Processing circuitry 404 may also be used to adjust the power supply voltages that are provided to portions of the circuitry on device 400. For example, higher direct-current (DC) power supply voltages may be supplied to active circuits and lower DC power supply voltages may be supplied to circuits that are less active or that are inactive. If desired, processing circuitry 404 may be used to implement a control scheme in which the power amplifier circuitry is adjusted to accommodate transmission power level requests received from a wireless network.

Input-output devices 406 may be used to allow data to be supplied to device 400 and to allow data to be provided from device 400 to external devices. Display screens, microphone acoustic ports, speaker acoustic ports, and docking ports are examples of input-output devices 406. For example, input-output devices 406 can include user input-output devices 408 such as buttons, touch screens, joysticks, click wheels, scrolling wheels, touch pads, key pads, keyboards, microphones, cameras, etc. A user can control the operation of device 400 by supplying commands through user input devices 408. Display and audio devices 410 may include liquid-crystal display (LCD) screens or other screens, light-emitting diodes (LEDs), and other components that present visual information and status data. Display and audio devices 410 may also include audio equipment such as speakers and other devices for creating sound. Display and audio devices 410 may contain audio-video interface equipment such as jacks and other connectors for external headphones and monitors.

Wireless communications devices 412 may include communications circuitry such as radio-frequency (RF) transceiver circuitry formed from one or more integrated circuits, power amplifier circuitry, passive RF components, antennas, and other circuitry for handling RF wireless signals. Wireless signals can also be sent using light (e.g., using infrared communications). Representatively, in the case of a speaker acoustic port, the speaker may be associated with the port and be in communication with an RF antenna for transmission of signals from the far end user to the speaker.

Returning to FIG. 4, device 400 can communicate with external devices such as accessories 414, computing equipment 416, and wireless network 418 as shown by paths 420 and 422. Paths 420 may include wired and wireless paths. Path 422 may be a wireless path. Accessories 414 may include headphones (e.g., a wireless cellular headset or audio headphones) and audio-video equipment (e.g., wireless speakers, a game controller, or other equipment that receives and plays audio and video content), a peripheral such as a wireless printer or camera, etc.

Computing equipment 416 may be any suitable computer. With one suitable arrangement, computing equipment 416 is a computer that has an associated wireless access point (router) or an internal or external wireless card that establishes a wireless connection with device 400. The computer may be a server (e.g., an internet server), a local area network computer with or without internet access, a user's own personal computer, a peer device (e.g., another portable electronic device), or any other suitable computing equipment.

Wireless network 418 may include any suitable network equipment, such as cellular telephone base stations, cellular towers, wireless data networks, computers associated with wireless networks, etc. For example, wireless network 418 may include network management equipment that monitors the wireless signal strength of the wireless handsets (cellular telephones, handheld computing devices, etc.) that are in communication with network 418.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting. For example, although a speaker is specifically disclosed herein, the attenuators disclosed herein could be used with other types of transducers, for example, microphones. Still further, although a portable electronic device in general is described herein, any of the previously discussed attenuator and transducer configurations may be implemented within devices such as wearable devices, earbuds, headphones, a mobile communications device, a tablet computer, personal computer, laptop computer, notebook computer and the like. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A reactive filter assembly comprising:
a reactive filter acoustically coupled to a transducer operable to generate an audio frequency by air non-linearity demodulation of an ultrasonic frequency, the reactive filter having a number of acoustic pathways tuned to introduce a radiation impedance to the transducer that improves transducer efficiency.

2. The reactive filter assembly of claim 1 wherein the reactive filter increases the radiation impedance to the transducer to improve the transducer efficiency.

3. The reactive filter assembly of claim 1 wherein the radiation impedance causes an amplified ultrasonic frequency output that leads to a gain in audio frequency output.

4. The reactive filter assembly of claim 1 wherein the reactive filter comprises a low pass filter.

5. The reactive filter assembly of claim 1 where each acoustic pathway of the number of acoustic pathways comprise an acoustic cavity, a first neck coupling the acoustic cavity to the transducer and a second neck.

6. The reactive filter assembly of claim 5 wherein a cross-sectional dimension of the acoustic cavity is greater than a cross-sectional dimension of the first neck or the second neck.

7. The reactive filter assembly of claim 5 wherein the first neck and the second neck have a same cross-sectional dimension, and the acoustic cavity has a cross-sectional dimension greater than the cross-sectional dimension of the first neck and the second neck.

8. The reactive filter assembly of claim 5 wherein the second neck couples the acoustic cavity to an attenuator configured to attenuate the ultrasonic frequency output by the transducer with the audio frequency.

9. A transducer assembly comprising:
a transducer operable to generate an audio frequency by air non-linearity demodulation of an ultrasonic frequency; and
a reactive filter assembly coupled to the transducer and having an acoustic pathway comprising a first cross-sectional dimension and a second cross-sectional dimension tuned to introduce a radiation impedance to the transducer that improves transducer efficiency.

10. The transducer assembly of claim 9 wherein the reactive filter assembly increases the radiation impedance to the transducer to improve the transducer efficiency.

11. The transducer assembly of claim 9 wherein the radiation impedance causes an amplified ultrasonic frequency output that leads to a gain in audio frequency output.

12. The transducer assembly of claim 9 where the first cross-sectional dimension defines an acoustic cavity and the second cross-sectional dimension defines a first neck coupling the acoustic cavity to the transducer and a second neck.

13. The transducer assembly of claim 12 wherein the first cross-sectional dimension of the acoustic cavity is greater than the second cross-sectional dimension of the first neck and the second neck, and the second neck couples the acoustic cavity to an attenuator configured to attenuate the ultrasonic frequency output by the transducer with the audio frequency.

14. The transducer assembly of claim 9 wherein the acoustic pathway is a first acoustic pathway, and the reactive filter assembly comprises a second acoustic pathway.

15. The transducer assembly of claim 9 wherein the transducer comprises a microelectromechanical systems speaker.

16. A portable electronic device comprising:
a device enclosure having an enclosure wall defining an interior chamber separated from a surrounding ambient environment;
a transducer positioned within the interior chamber and operable to generate an audio frequency by air non-linearity demodulation of an ultrasonic frequency; and
a reactive filter assembly coupled to the transducer and having a number of acoustic pathways tuned to introduce a radiation impedance to the transducer that improves transducer efficiency.

17. The portable electronic device of claim 16 wherein the reactive filter assembly increases the radiation impedance to the transducer and the radiation impedance causes an amplified ultrasonic frequency output that leads to a gain in audio frequency output.

18. The portable electronic device of claim 16 wherein the reactive filter assembly comprises a low pass filter.

19. The portable electronic device of claim 16 where each acoustic pathway of the number of acoustic pathways comprise an acoustic cavity, a first neck coupling the acoustic cavity to the transducer and a second neck coupling the acoustic cavity to an attenuator configured to attenuate the ultrasonic frequency output by the transducer with the audio frequency.

20. The portable electronic device of claim 19 wherein a cross-sectional dimension of the acoustic cavity is greater than a cross-sectional dimension of the first neck and the second neck.
